(19) United States
(12) Patent Application Publication
(10) Pub. No.: US 2026/0356219 A1
(43) Pub. Date: Nov. 12, 2026

(54) Socket Arrangement, Motor Vehicle and Supply Arrangement

(71) Applicant: BAYERISCHE MOTOREN WERKE AKTIENGESELLSCHAFT, Muenchen (DE)

(72) Inventor: Etienne ILIFFE-MOON, Menlo Park, CA (US)

(21) Appl. No.: 19/111,889

(22) PCT Filed: Sep. 4, 2023
(86) PCT No.: PCT/EP2023/074168

§ 371 Date: Mar. 14, 2025

(30) Foreign Application Priority Data
Sep. 23, 2022 (DE) 10 2022 124-498.9

(51) Int. Cl. B60L 53/16; B60L 53/302; H01R 13/00; H01R 13/627

(52) U.S. Cl. CPC B60L 53/16; B60L 53/302; H01R 13/005; H01R 13/6273

(57) ABSTRACT

A socket arrangement for a plug of a motor vehicle has an opening, a displaceable contact element, a positioning element and one or more contacts. The plug can push the contact element inwards. The invention also relates to an associated motor vehicle and to an associated supply arrangement.

### BACKGROUND AND SUMMARY

The invention relates to a socket arrangement for a plug of a motor vehicle, an associated motor vehicle and an associated supply arrangement for a motor vehicle.

With battery-electric vehicles becoming increasingly widespread, charging up the vehicles becomes an increasingly important consideration in the development of vehicles. Previous battery-electric vehicles typically have sockets which are arranged at points at which equivalent vehicles having internal combustion engines have tank filler necks. Accordingly such sockets are typically located behind flaps which are opened before a charging process, which stay open during a charging process and which are closed again afterwards. This typically requires a manual operation and involves the risk of such covers or flaps being torn off.

Thus it is the object of the invention to provide a socket arrangement for a plug of a motor vehicle which is easier to use, for example in comparison with known embodiments. It is also an object of the invention to provide an associated motor vehicle and an associated supply arrangement for a motor vehicle. This is achieved according to the invention by a socket arrangement, a motor vehicle and a supply arrangement according to the respective main claims.

The invention relates to a socket arrangement for a plug of a motor vehicle. The socket arrangement has an opening. The socket arrangement has a support element which is mounted so as to be movable in a linear manner between two positions, wherein the support element in the first position closes the opening and in the second position is spaced apart from the opening on an inner face, so that a plug which enters through the opening from an outer face opposing the inner face can contact the support element. The socket arrangement has a positioning element which is configured to hold the support element in the second position and/or to hold in position a plug bearing against the support element in the second position thereof. Moreover, the socket arrangement has one or more contacts which are configured to contact a plug which enters through the opening and bears against the support element located in the second position.

Advantageously, by means of such a socket arrangement a flap for covering a socket can be dispensed with. The support element can close an opening, wherein such an opening can be, for example, an opening in a vehicle body and can also ensure a fixing and comfortable guidance of the plug. As a result, the charging process is significantly simplified and carried out more conveniently for the user. This leads to a significantly improved user experience when charging, simpler operation by reducing working steps and by multi-sided accessibility, and a reduction of risk factors such as for example protruding flaps potentially being tom off.

The opening can be configured, for example, in a body of a motor vehicle. The opening can be bordered, for example, by a suitable edging such as for example an opening edge. The opening can be configured, for example, in a complementary manner to a plug.

The support element can be, for example, a block which is configured such that it bears against a surface of the plug and accordingly can be introduced into a motor vehicle together with the support element. The support element is typically displaced inwards. The support element can also be implemented, for example, as a metal plate or as a different thin design. Typically the support element predetermines a position of the plug when introduced, at least up to a movement along a predetermined route. Thus when the plug is introduced, the support element is typically displaced further into the motor vehicle and can also ensure a suitable positioning of the plug, in particular at that point.

The positioning element can serve, in particular, during a charging process to hold the support element and/or the plug in position so that the charging process can take place without monitoring. A removal of the plug or an undesired displacement of the support element is prevented thereby. Possible embodiments are specified below, for example. The positioning element can be implemented in an automated or semi-automated manner. This positioning element can serve to bring and/or to hold the plug automatically in position. However, a manual actuation is also possible, for example, in order to save weight and/or costs. Moreover, with a semi-automated embodiment a manual emergency actuation is possible in order to permit a release of the plug, for example in the case of power failure. A lever can be provided for manual actuation or emergency actuation, for example. This can ensure that the plug is manually gripped and/or moved by the positioning element.

The contacts can serve, for example, to receive electrical power from the plug, to exchange data with the plug or to obtain a fluid such as for example a coolant, liquid fuel or another working fluid from the plug. The contacts are thus to be understood in general terms in principle. In the case of battery-electric vehicles, in particular the contacts can be electrical contacts by which power can be obtained from the plug. Additionally, contacts for data exchange can be present, for example. Moreover, a contact or a plurality of contacts can be present, for example, in order to supply a suitable cooling medium to the motor vehicle. Thus, for example, a battery can be cooled during a charging process. In principle, however, the socket arrangement described herein is also suitable for supplying vehicles having an internal combustion engine, since contacts, for example, can also receive liquid working fluids, such as for example liquid fuel. A transmission is also possible of gas which can be a combustible gas, for example, which can serve for driving a motor vehicle.

In principle, a bi-directional flow of energy, media or data is possible. For example, in this manner power can be discharged from a vehicle so that it can be used externally, for example as an emergency power supply.

According to an advantageous embodiment, the support element has a notch or a projection for centering the plug in one side, the notch or projection being oriented in the first position toward the outer face. As a result, the plug can be easily centered when introduced, so that when introduced through the opening it fits exactly through this opening. A notch can be configured, for example, such that a projection of the plug which is complementary thereto engages in the notch. As a result, the plug can be centered. In the case of a projection on the support element this can be implemented in reverse, for example.

According to one embodiment, the support element has a magnet arrangement for attracting and/or centering the plug. The plug can also be centered by the magnet arrangement. Moreover, a haptic or tactile feedback that the plug is correctly positioned can be provided to a user. The magnet arrangement can also serve to hold the plug in position even before it passes through the opening so that the operation is facilitated. Typically the magnet arrangement can be designed such that the plug is held, but it can be removed again by using a force which can be manually applied. For example, a suitable counter magnet or a suitably magnetically active material can be configured in the plug so that an attraction takes place between the magnet arrangement and the plug.

According to an advantageous embodiment, the positioning element is configured for positive engagement in the plug. As a result, the plug can be held in position in a targeted manner. If the positioning element is brought out of positive engagement, the plug is released again. A positive hold of the plug in the socket arrangement serves, in particular, for securing a longer-lasting and unsupervised charging process, wherein in particular an inadvertent or even a deliberate removal of the plug is prevented while a vehicle is being charged.

The positioning element can be configured, in particular, to grip the plug after insertion through the opening and to move the plug further therein, wherein the support element is moved into the second position. The operation can be assisted by means of such an embodiment, wherein it can be sufficient, for example, to push the plug only a small distance through the opening, whereas the remainder of a required travel path is implemented in an automated manner by the positioning element. As a result, the operation can be further simplified and manual operating errors can be reduced.

Advantageously the positioning element can have plug identification means which identify an insertion of the plug through the opening and activate the positioning element in response thereto, in particular in order to grip the plug and/or to move the support element into the second position. As a result, it can be sufficient to plug the plug through the socket only by a small distance so that the plug identification means identify the presence of the plug. For example, the support element can be moved or pushed in by a small distance.

In particular, the positioning element can be configured as a clamp. The clamp can perform, for example, a gripping movement entirely or substantially transversely to a travel path of the support element and/or the plug, in order to grip the plug and to release it again. In the state in which the plug is gripped, the positioning element can be used for actively moving and/or holding the plug.

The support element can be designed, in particular, in a block-shaped manner. This can mean, for example, that the support element is a solid piece, for example, made of plastics or of metal. Alternatively the support element can be designed, for example, as a plate or disk.

In particular, the socket arrangement can have a rail system for movably mounting the support element. In particular, the rail system can ensure that the support element can be moved in exactly one dimension. A movement in other directions, in particular perpendicular thereto, can be effectively prevented.

In particular, the first position can be an end position of the support element. In particular, the second position can be an end position of the support element. In particular, it can thus be provided that the support element is displaceable in a linear manner between the first position and the second position but is not displaceable further.

The socket arrangement can advantageously have a pretensioning device which pretensions the support element into the first position. This can ensure that, with the absence of a plugged-in plug or other influences, the support element closes the opening and, in particular, thereby prevents the ingress of dirt or moisture. In addition, the support element can deploy its action for guiding and centering a plug from the first position. The pretensioning device can be configured, for example, as a spring or as an elastomer or other resilient element. An elastomer can be configured, for example, to be weatherproof and/or also serve for sealing against moisture or dirt.

The opening can be surrounded, in particular, by a body of the vehicle and/or by an opening edge. Such a body or an opening edge can define, in particular, the opening through which the plug can be subsequently plugged.

The opening can be surrounded, in particular entirely or partially, by a lighting element. The lighting element can be designed, for example, as an edge surrounding the opening. As a result, locating the socket arrangement or the opening in the dark can be simplified.

The socket arrangement can have, for example, a heating element. This can prevent the socket arrangement from freezing. For example, it can be ensured thereby that the support element remains movable relative to the opening.

The support element and/or other components of the socket arrangement can have, for example, an oil-repellent and/or water-repellant coating. This can achieve a certain self-cleaning effect.

The plug can be, in particular, an electrical plug. In particular, the contact or the contacts can be electrical contacts. As a result, an electrical supply to a motor vehicle can be achieved. For example, a battery-electric vehicle or a plug-in hybrid vehicle can be charged up.

According to one embodiment, the socket arrangement has a port in order to receive a fluid from the plug. As a result, for example, it is possible to supply a coolant which can cool a battery of the motor vehicle during a charging process. Other fluids, such as for example liquid fuel or wiper washer fluid for example, can also be received by the plug in this manner. The port can also be understood, for example, as a contact.

The invention further relates to a motor vehicle having a socket arrangement as described herein. Relative to the socket arrangement all of the embodiments described herein can be referred to. The aforementioned advantages can be achieved thereby.

In particular, it is possible that the socket arrangement is not covered by a flap on the outside. As a result an additional cover is avoided, which saves effort when using a plug with the socket arrangement and prevents such a flap being torn off. The number of required working steps is reduced. In the known embodiments of socket arrangements typically they are covered by a flap similar to a fuel tank cap of a motor vehicle having an internal combustion engine, wherein such flaps in principle are susceptible to being tom off when handled incorrectly. By dispensing with a flap there is no drawback in the embodiment described herein, since the support element closes the socket when not in use and thus prevents an ingress of dirt or moisture. As an alternative to the wording that the socket arrangement is not covered on the outside by a flap, it is possible to use the wording that the socket arrangement or the opening is arranged directly on the outer face of the motor vehicle.

The invention further relates to a supply arrangement for a motor vehicle having a socket arrangement as described herein and a plug which is configured for cooperating with the socket arrangement. The plug can be designed, for example, such that it can be inserted through the opening, it is centered by the support element, when inserted into the socket it pushes the support element into the second position and/or is held by the positioning element in the second position or is actively displaced in a linear manner into the second position. This permits an advantageous cooperation of the plug and socket arrangement.

The plug can have, for example, a handle which can be curved, for example. This permits an elegant design and a simple handling. Expressed in general terms, the plug can have a region or a plurality of regions on which the user can grip the plug.

The plug can have, in particular, a shape and/or dimension such that it closes the opening after insertion, in particular closes the opening against the ingress of water and/or dirt.

For actuating the plug, for example, it is possible to provide a robot arm or another handling device which can be a constituent part of a charging station, for example. As a result, it can be sufficient if a vehicle is driven to a specific position in order to charge it up. The robot arm or the handling device can introduce the plug into the socket arrangement in a targeted manner and move the plug such that the support element is moved into the second position. In this state, it is possible to charge up and/or refuel the vehicle.

In particular, a new universal standard for vehicles such as electrically operated motor vehicles, including motorcycles or scooters, for example, can be provided by the embodiment described herein. In particular, in motorcycles or scooters a manual actuation can be provided in order to save weight and costs. Nevertheless, the same operating concept and the same plug can be used.

The size of the socket arrangement can be minimized by the design described herein. A flap can be advantageously dispensed with. An assistance can be provided to the user by the plug being able to be centered, as already described. For example, this can take place by means of a permanent magnet and/or an electromagnet. Additionally or alternatively, it is possible to use complementary geometric structures such as for example a projection and a notch. The plug typically comes into contact with components of the socket arrangement initially on the support element. For example, lighting elements can be arranged on the socket arrangement and/or on the plug, in order to permit a reliable operation even at night.

A data communications protocol can be used in order to identify and/or to authenticate a plug in a wired or wireless manner. For example, it can be checked whether the plug is compatible. Moreover, it can be established whether the vehicle is locked and/or in a driving mode, for example. A communication with a vehicle charging system can be created, for example, in order to bring about the opening of a door or a flap in order to monitor and/or to control a charging state (for example in combination with or independently of wired and/or wireless signals), in order to terminate the charging and/or in order to eject or release the plug. Moreover, it is possible to communicate with a charging station, for example, in order to control and/or to monitor the charging status in order to permit a user interaction by means of a graphic user interface or for other purposes, such as for example payment processing. A touch-sensitive screen and/or a keyboard can be used for a user interaction, for example. The near field communication can take place via any suitable wireless data communications protocol such as NFC, RFI, UWB, IR, etc. A wired communication is also possible.

As soon as the user attaches the plug to the support element and pushes it slightly inwards (assisted by a centering device and/or a magnet) a plug detector can detect the position or the presence of the plug and move the support element further inwards and/or pull the plug inwards, wherein actuated mechanical elements, for example for the retraction, can form a positive engagement, in particular immediately. For example, claws can be used therefor. These claws can be attached, in particular, in a displaceable manner or to a displaceable slide. For the retraction, such an element can be driven for example electromechanically, for example by means of a motor, a linear actuator, etc. The plug can be retracted, in particular, as far as an end position, for example until the support element is in its second position. Then the contacts can ensure a connection of the plug, so that for example an electrical current can be transmitted into the vehicle, for example in order to charge up a battery.

In particular, the socket arrangement described herein has its own closing mechanism. In particular, the support element can close the opening. If the plug is in a charging position the support element typically is no longer visible and the plug protrudes from the vehicle.

A status display can also be implemented, for example, by means of the aforementioned lighting elements. For example, a red light can be displayed when charging up, whereas a green light can be displayed after the charging process is terminated.

The invention is now described in more detail with reference to the figures.

### BRIEF DESCRIPTION OF THE DRAWINGS

FIG. 1: shows a supply arrangement;

FIG. 2: shows a plug;

FIG. 3: shows a plug and a socket arrangement in a first state;

FIG. 4: shows the plug and the socket arrangement of FIG. 3 in a second state; and

FIG. 5: shows the plug and the socket arrangement of FIG. 3 in a third state.

### DETAILED DESCRIPTION OF THE DRAWINGS

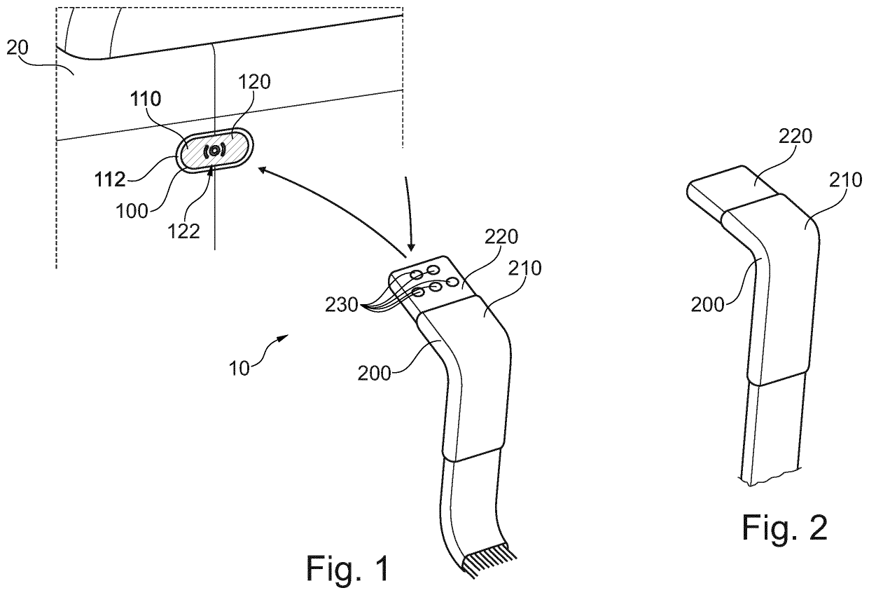

FIG. 1 shows a supply arrangement 10 for a motor vehicle 20. The supply arrangement 10 has a socket arrangement 100 and an associated plug 200. The motor vehicle 20 in the present case is a battery-electric vehicle which can be charged by means of the plug 200. To this end, the socket arrangement 100 and plug 200 cooperate, as will be explained below in more detail.

The socket arrangement 100 has an opening 110 which is surrounded by an opening edge 112. The opening 110 is configured in a body of the motor vehicle 20, only shown schematically. A support element 120, which in the state shown closes the opening 110, is located inside the opening 110. An ingress of dirt or water through the opening 110 is effectively prevented thereby. A notch 122 which serves for centering the plug 200 in a manner described below is located centrally in the support element 120.

The plug 200 has substantially a handle 210 and a contact element 220. In the present case, five contacts 230 are arranged on the contact element 220. These contacts can be used, in particular, for transmitting power and also for transmitting data.

In particular, the opening edge 112 can be illuminated. The locating of the opening 110 can be facilitated thereby. In addition, a status display can be implemented thereby, wherein for example a red light is displayed during a charging process and a green light is displayed after the charging process is terminated. An error status can also be displayed, for example by means of a different color or by a flashing light. The opening edge 112 can have, for example, one or more light-emitting diodes or other light-emitting elements.

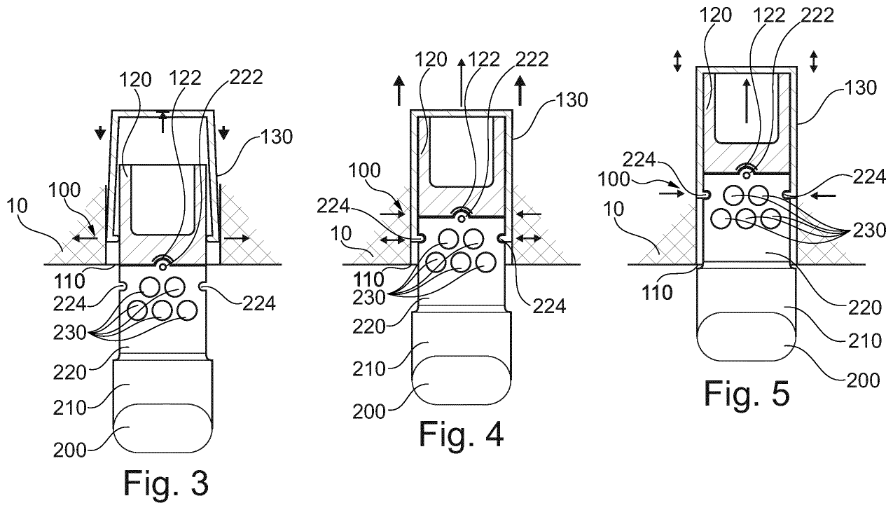

The exact cooperation of the socket arrangement 100 and plug 200 is described in more detail below with reference to FIGS. 3 to 5.

FIG. 2 shows a plug 200 in an alternative embodiment. In contrast to the embodiment of FIG. 1, the contacts 230 are not arranged on the top side but on the bottom side, so that they are not visible in the view of FIG. 2. Otherwise, reference should be made to the embodiments of FIG. 1.

FIG. 3 shows the plug 200 and the socket arrangement 100 in a first state.

As shown, the contact element 220 of the plug 200 on the front face has a projection 222 which engages in the notch 122 of the support element 120. A fixing and centering of the plug 200 on the support element 120 is implemented thereby. Two notches 224 which serve for gripping the plug 200 in the manner described with reference to FIG. 4 are formed at the side on the contact element 220.

The support element 120, as shown by arrows, can be displaced into the motor vehicle 20 from the first position, shown in FIG. 3, in which it closes the opening 110. This is carried out by a guide, not shown, which ensures exactly a one-dimensional mobility of the support element 120 along a predetermined path of travel.

The socket arrangement 100 additionally has a positioning element 130 which is designed as a clamp. The lower side of the positioning element 130 in FIG. 3 can be slightly enlarged on the bottom side—as indicated by outwardly facing arrows—so that the contact element 220 of the plug 200 can be passed through. This is described hereinafter with reference to FIG. 4.

FIG. 3 shows a state in which the support element 120 is in its first position and thus closes the opening 110.

Starting from this state the plug 200 can be pushed in slightly further, whereby the state shown in FIG. 4 is produced. The support element 120 is pushed slightly further inwards which can be carried out, for example, by a manual application of force. This can take place, in particular, counter to a pretensioning of the support element 120 into the first position. In the state shown in FIG. 4, the positioning element 130 can engage in the notches 224 of the plug 200 and thus grip the plug. This can take place, in particular, in an automated manner, for example after a plug detector, not shown, has identified the penetration of the plug 200.

Then the positioning element 130 can pull the plug 200 further into the motor vehicle 20 so that the state shown in FIG. 5 is produced. The support element 120 is also moved further into the motor vehicle 20 so that it is in a second position which is shown in FIG. 5. The first position shown in FIG. 3 and the second position shown in FIG. 5 represent respective end positions along the intended travel path of the support element 120.

In the state which is shown in FIG. 5 the contacts 230 of the plug 200, in particular, can be electrically contacted by contacts of the socket arrangement 100, not shown, so that a charging up of the motor vehicle 20 and also a data exchange are possible. After such a charging process is terminated, the positioning element 130 can move the plug 200 back in the direction of the opening 110. In particular, the positioning element can release the plug 200 again, for example such that the state shown in FIG. 3 is adopted again. Due to its pretensioning, the support element 120 travels back into its first position and closes the opening 110. The plug 200 can then be removed in a manual or automated manner and can be taken out from the motor vehicle 20. The charging process is then terminated.

In particular, a simple and intuitive handling is achieved by the embodiment described herein, wherein an additional tank flap or a similar flap can be eliminated. This avoids the flap being tom off, and the operation is simplified.

List of reference signs

| | |
|---|---|
| 10 | Supply arrangement |
| 20 | Motor vehicle |
| 100 | Socket arrangement |
| 110 | Opening |
| 112 | Opening edge |
| 120 | Support element |
| 122 | Notch |
| 130 | Positioning element |
| 200 | Plug |
| 210 | Handle |
| 220 | Contact element |
| 222 | Projection |
| 224 | Notch |
| 230 | Contacts |

1.-18. (canceled)

19. A socket arrangement for a plug of a motor vehicle, comprising:
an opening of the socket arrangement;
a support element which is mounted so as to be movable in a linear manner between two positions, wherein the support element in a first position closes the opening and in a second position is spaced apart from the opening on an inner face, so that a plug which enters through the opening from an outer face opposing the inner face can contact the support element;
a positioning element which is configured to hold the support element in the second position and/or to hold in position the plug bearing against the support element in the second position thereof; and
one of more contacts which are configured to contact the plug which enters through the opening and bears against the support element located in the second position.

20. The socket arrangement according to claim 19, wherein
the support element has a notch or a projection for centering the plug on one side, the notch or projection being oriented in the first position toward the outer face.

21. The socket arrangement according to claim 19, wherein
the support element has a magnet arrangement for attracting and/or centering the plug.

22. The socket arrangement according to claim 19, wherein
the positioning element is configured for positive engagement in the plug.

23. The socket arrangement according to claim 19, wherein
the positioning element is configured to grip the plug after the plug is inserted through the opening and to move the plug further therein, wherein the support element is moved into the second position.

24. The socket arrangement according to claim 23, wherein
the positioning element has a plug identifier which identifies an insertion of the plug through the opening and activates the positioning element in response thereto, in order to grip the plug and/or to move the support element into the second position.

25. The socket arrangement according to claim 19, wherein
the positioning element is configured as a clamp.

26. The socket arrangement according to claim 19, wherein
the support element is designed in a block-shaped manner.

27. The socket arrangement according to claim 19, wherein
the socket arrangement has a rail system for movably mounting the support element.

28. The socket arrangement according to claim 19, wherein
the first position is an end position of the support element, and/or the second position is an end position of the support element.

29. The socket arrangement according to claim 19, further comprising:
a pretensioning device which pretensions the support element into the first position.

30. The socket arrangement according to claim 19, wherein
the opening is surrounded by a body of the motor vehicle and/or by an opening edge.

31. The socket arrangement according to claim 19, wherein
the opening is surrounded entirely or partially by a lighting element.

32. The socket arrangement according to claim 19, wherein
the plug is an electrical plug, and/or
the one or more contacts is or are electrical contacts.

33. The socket arrangement according to claim 19, further comprising:
a port in order to receive a fluid from the plug.

34. A motor vehicle comprising a socket arrangement according to claim 19.

35. The motor vehicle according to claim 34, wherein
the socket arrangement is not covered by a flap on an exterior thereof.

36. A supply arrangement for a motor vehicle, comprising:
a socket arrangement according to claim 19; and
a plug which is configured for cooperating with the socket arrangement.
